(19) United States
(12) Patent Application Publication
(10) Pub. No.: US 2024/0200598 A1
(43) Pub. Date: Jun. 20, 2024

(54) SHELL BEARING FOR INTERNAL COMBUSTION ENGINES

(71) Applicants: MAHLE METAL LEVE S/A, Jundiai, SP (BR); MAHLE INTERNATIONAL GMBH, Stuttgart (DE)

(72) Inventor: Matheus dos Santos Ferreira, Jundiai (BR)

(21) Appl. No.: 17/802,943

(22) PCT Filed: Feb. 26, 2021
(86) PCT No.: PCT/EP2021/054848

§ 371 Date: Aug. 26, 2022

(30) Foreign Application Priority Data
Feb. 27, 2020 (BR) 1020200039474

(51) Int. Cl. F16C 33/10; F16C 17/02

(52) U.S. Cl. CPC F16C 33/1065; F16C 17/022; F16C 2360/22

(57) ABSTRACT

A shell bearing of an internal combustion engine is disclosed. The shell bearing includes two semicircular segments defining a profile of the shell bearing. A constant oil groove is provided extending longitudinally and in a centralized manner along an internal surface of at least one of the two segments. The oil groove has a volume in a proportion of up to 10% of a volume of the shell bearing.

### CROSS-REFERENCE TO RELATED APPLICATIONS

This application claims priority to International Patent Application No. PCT/EP2021/054848 filed Feb. 26, 2021, which also claims priority to Brazilian Patent Application No. BR 10 2020 003947 4 filed Feb. 27, 2020, the contents of each of which is hereby incorporated by reference in their entirety.

### TECHNICAL FIELD

The present invention relates to a shell bearing for combustion engines. Specifically, the present invention relates to a shell bearing comprising an oil groove optimized such that, when functioning, it reduces the flow of oil utilized at the same time as maintaining those appropriate to the conditions of functioning of the engine.

### BACKGROUND

Internal combustion engines comprise, essentially, an engine block, comprising one or more cylinders and a cranked shaft assembly or crankshaft assembly wherewith are associated one or more heads, wherein, in turn, the cranked shaft assembly is composed of pistons, connecting rods and by the crankshaft.

The connecting rod is the part interconnecting a piston to the crankshaft, converting the alternating rectilinear motion of the piston within the interior of the cylinder into a continuous angular movement of the crankshaft. The connecting rod is provided, basically, with a large hole or eye referred to as the connecting rod head, wherewith is associated a crankshaft, a stem or body, and a small hole or eye referred to as the connecting rod foot, it being affixed to a piston by means of a gudgeon or pin.

During the functioning of the engine the piston(s) move linearly and reciprocally. The respective connecting rod moves connectedly with each piston, and the head thereof, associated with the crankshaft, describes a circular movement resulting in the angular motion of the crankshaft.

In order to render possible the correct functioning of the engine it is necessary that the contact between the crankshaft and the other components of the engine be realized by means of bearings, more commonly known as shell bearings or bushings. Whatever the specific configuration thereof may be, they are generally known as sliding bearings.

In an internal combustion engine the sliding bearings may be utilized (i) as crankshaft bearings in relation to the engine block, (ii) as connecting rod bearings in relation to the crankshaft, and (iii) as camshaft bearings, inter alia other less common applications.

Specifically, the bearings developed for utilization upon the crankshaft are referred to as shell bearings. In general, the shell bearings comprise two segments of a ferrous metal, principally of steel, each segment forming a semicircular or ‘C’ shaped half (having the objective of facilitating fitting upon a connecting rod), the two segments being associated in annular format, similar to a sleeve.

The external surface of a shell bearing presents characteristics of hardness capable of permitting a firm contact with the housing thereof, without deformations, ensuring the correct support thereof and providing the correct dissipation of heat generated through attrition (friction), in this manner preventing overheating of the assembly.

Conversely, the internal surface of the shell bearings comprises a coating which may be composed by several metal alloys such as, for example and inter alia, alloys based upon copper or upon aluminum, always seeking resistance to abrasion and to wear, in addition to good conformability, providing a long working life, including under severe conditions of operation of the engine.

Whereas a shell bearing may of itself realize the function of reduction of friction, the performance thereof is greatly improved through the addition of a lubricant between the moving part (crankshaft) and the internal surface of the shell bearing. For this reason one of the principal objectives of the design of a shell bearing is to establish and maintain a film of oil between these surfaces, generally under variable and high impact loads.

In normal operation the crankshaft and the internal surface of the shell bearing are maintained separated from one another by a film of oil formed therebetween under a condition of hydrodynamic lubrication.

In this respect, the maximization of this film of oil is predominant in the working life of the shell bearing and of the other components in order to prevent contact between the crankshaft and the bearing. Consequently, what is sought is to design shell bearings such as to provide the greatest possible thickness of the film of oil compatible with the characteristics of the system of lubrication of the engine.

In this context, the document U.S. Ser. No. 10/072,699 refers to a shell bearing comprising upon one of the segments thereof a partial oil groove, that is to say a section extending through approximately 45° of the total extent of 180° of the segment of shell bearing.

However, it is observed that a partial oil groove does not render possible the maximization of the film of oil, in other words an oil groove of the state of the art does not render the best film of oil possible by virtue of the fact that the section thereof does not span the entire segment of the shell bearing.

The documents U.S. Pat. No. 8,905,639 and CN100580261 refer to a shell bearing comprising, in one of the segments thereof, a variable oil groove extending through the 180° of the total extent of the segment of shell bearing.

However, although functional, this solution found in the state of the art does not define an optimum oil groove, such that it does not achieve the best possible performance of the shell bearing.

This is because a variation in the oil groove of the shell bearing impacts directly upon the condition of hydrodynamic lubrication of the crankshaft and connecting rod assembly associated with the shell bearing.

As a consequence thereof, the obtainment is rendered necessary of a shell bearing for internal combustion engines comprising, in one of the segments thereof, a constant oil groove extending through the 180° of the extent of the segment of shell bearing such as to obtain better performance from the assembly of the crankshaft and the connecting rod associated with the shell bearing.

### SUMMARY

The present invention has as object the provision of a shell bearing for internal combustion engines comprising an oil groove optimized to reduce the flow of oil, it being maintained appropriate to the conditions of functioning of the engine.

The provision of a shell bearing for combustion engines, comprising an oil groove provided with a specific area/volume resulting in an improved condition of the film of oil under conditions of reduction of the flow of oil, is also an object of the present invention.

Furthermore, an object of the present invention is the provision of a shell bearing for utilization in engines wherein the demand for oil for the bearings is reduced without increase in cost.

Having the objective of overcoming the disadvantages of the state of the art, the objects of the present invention are achieved by means of a shell bearing for internal combustion engines provided with two semicircular segments defining a profile of shell bearing, the shell bearing comprising a constant oil groove extending longitudinally and in a centralized manner along the internal surface of at least one segment of the shell bearing and the oil groove comprising a volume in the proportion of up to 10% of the volume of the shell bearing.

The objects of the present invention are also achieved through a shell bearing comprising an oil groove having the shape of one from among trapezoidal, rectangular and square.

Furthermore, the objects of the present invention are achieved by a shell bearing comprising an oil groove configured for a substrate of aluminum or bronze, the substrate being coated or not.

### BRIEF DESCRIPTION OF THE DRAWINGS

The present invention shall now be described in greater detail below on the basis of an example of embodiment represented in the drawings. The figures show:

FIG. 1a: a perspective view of a first segment of shell bearing of the state of the art;

FIG. 1b: a perspective view of a second segment of shell bearing of the state of the art;

FIG. 2: a perspective view of a segment of shell bearing, object of the present invention;

FIG. 3: a representation of the types of oil grooves of the segment of shell bearing shown in FIG. 2;

FIG. 4: a representation of the results of the simulation test, and

FIG. 5: a representation of the results of the engine test.

### DETAILED DESCRIPTION OF THE DRAWINGS

As has previously been revealed in the state of the art, shell bearings comprise sliding bearings the function whereof consists in reducing the friction between the crankshaft and a connecting rod associated therewith.

In addition, the performance of a shell bearing is significantly improved through the addition of a lubricant between the moving part (crankshaft) and an internal surface of the shell bearing.

For this reason, one of the principal objects of the design of a shell bearing is to establish and maintain a film of oil between these surfaces, generally under variable and high impact loads.

Consequently, the maximization of this film of oil, such as to prevent the contact between the crankshaft and the bearing, is predominant in the working life of the shell bearing and of the other components.

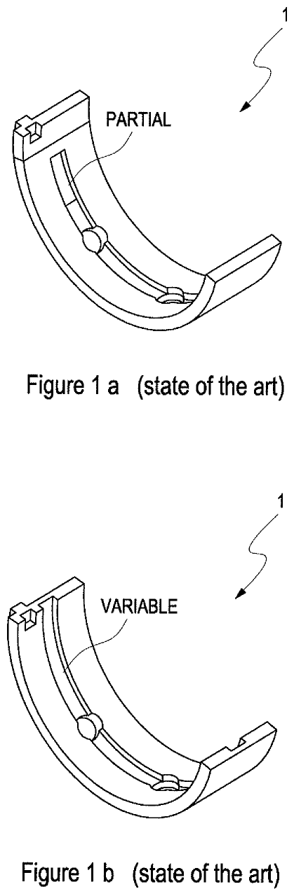

In FIGS. 1a and 1b there may be observed a semicircular segment, or one half, of a shell bearing of the state of the art for use in internal combustion engines, wherein in FIG. 1a there is shown a shell bearing comprising a partial oil groove, that is a say a section extending from approximately 45° to 160° of the total extent of 180° of a segment of shell bearing, and in FIG. 1b there is shown a shell bearing comprising a variable oil groove extending along the 180° of the total extent of a segment of shell bearing.

In this manner, as previously stated, these shell bearings of the state of the art do not define an optimum oil groove, such that they do not achieve the best possible performance of the shell bearing.

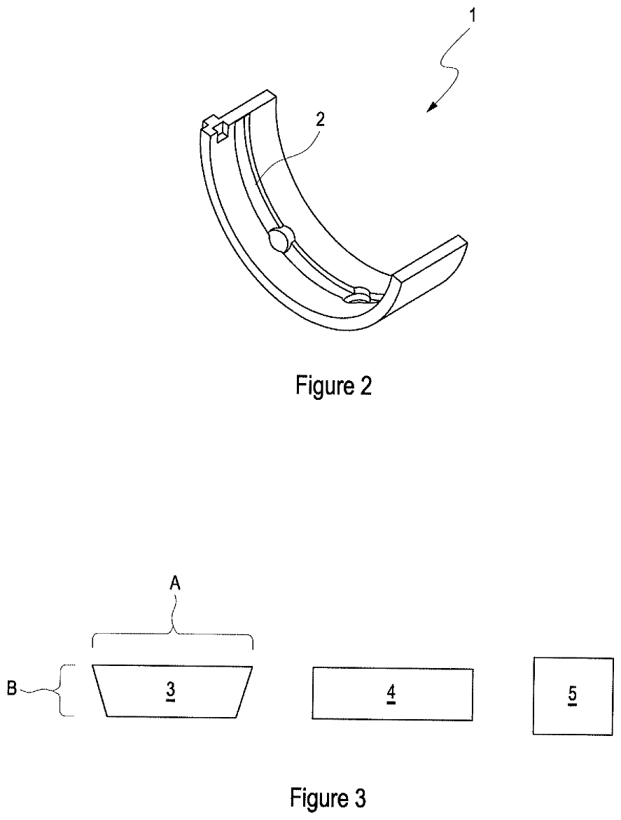

In contrast, the object of the present invention, as may be observed in FIG. 2, relates to a shell bearing comprising a constant oil groove 2 extending through the 180° of the total extent of a segment 1 of shell bearing.

Specifically, the object of the present invention relates to a shell bearing for internal combustion engines provided with two semicircular segments 1 defining a profile of shell bearing comprising a constant oil groove 2 extending longitudinally and in a centralized manner along the internal surface of at least one segment 1 of the shell bearing, the oil groove 2 comprising a volume in the proportion of up to 10% of the volume of the shell bearing.

More specifically, the oil groove 2 of the shell bearing for internal combustion engines, object of the present invention, comprises groove width A and groove depth B which may vary between 1 mm and 7 mm and 0.1 mm and 2 mm, respectively, depending on the conditions and applications of the design.

Furthermore, as may be observed in FIG. 3, the oil groove 2 of the shell bearing in addition to being constant may, furthermore, comprise a shape of one from among trapezoidal 3, rectangular 4 and square 5.

It must be emphasized that these shapes are not limitative for the object of the invention, such that any shapes of oil grooves 2 comply with the object of the invention, always provided that they comprise a volume of up to 10% of the volume of the shell bearing in addition to the oil groove 2 being constant.

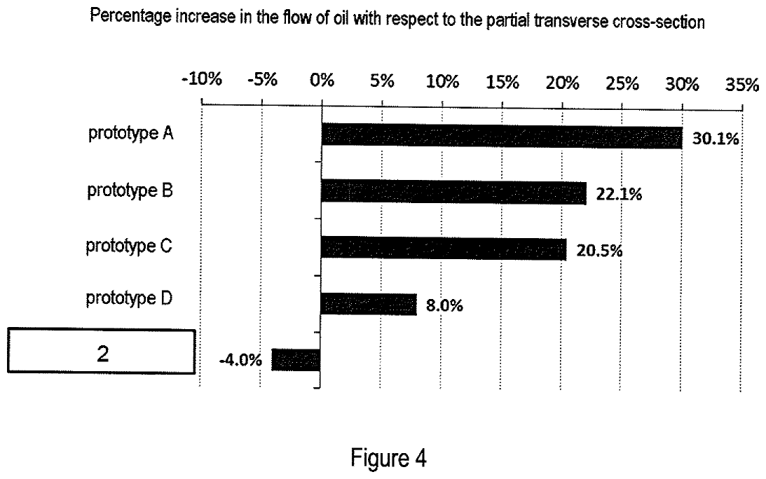

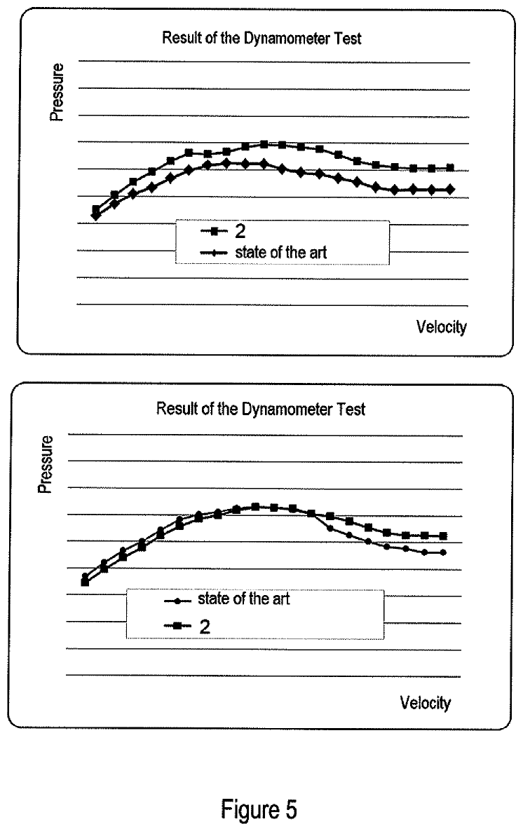

Advantageously, as shown in FIGS. 4 and 5, the shell bearing of the present invention is differentiated from the state of the art by virtue of the results of the tests executed, that is to say, simulation test and engine test.

Specifically, the results of the tests have demonstrated a reduction in the flow of oil (simulation test) together with better performance (engine test) on increasing the pressure of the oil of the shell bearing of the present invention when compared with the shell bearings of the state of the art.

Consequently, in the graph shown in FIG. 4 (simulation test) the flow of oil is compared for some geometries of oil groove 2 of the shell bearing of the present invention in comparison with the traditional designs. As may be observed a reduction of 4% in the flow of oil utilized has been found.

In relation to the graphs shown in FIG. 5 (engine test), wherein the dark blue lines refer to the oil groove 2 of the shell bearing of the present invention and the light blue and red lines refer, respectively, to the variable and partial oil grooves of the state of the art, the results of the tests demonstrate a better performance of the shell bearing of the present invention.

Consequently, advantageously, the shell bearing of the present invention furnishes an optimized oil groove to reduce the flow of oil, maintaining appropriate conditions of functioning of the engine.

In addition thereto, in an alternative configuration the shell bearing comprises an oil groove 2 configured for a substrate of aluminum or bronze, wherein the internal surface of the segments 1 comprise, or not, a coating.

Consequently, the present invention presents a shell bearing being advantageous over the state of the art, specifically by virtue of providing an improved condition in the flow of oil, through the use of a constant oil groove 2, when compared with the oil grooves of the state of the art, in this manner rendering possible the utilization thereof in engines wherein the demand for oil requires to be reduced without increase in cost.

Furthermore, the solution yielded by the present invention has been validated by means of simulation and engine tests, wherein the results have demonstrated advantages for the shell bearing of the present invention.

An example of preferred embodiment having been described, it shall be understood that the scope of the present invention comprises other possible variations, being limited solely by the content of the appended claims, the possible equivalents being included therein.

1. A shell bearing for an internal combustion engines, comprising:
two semicircular segments defining a shell bearing profile,
a constant oil groove extending longitudinally and in a centralized manner along an internal surface of at least one of the two segments, and
wherein the oil groove comprises a volume in a proportion of up to 10% of a volume of the two semicircular segments.

2. The shell bearing as claimed in claim 1, wherein the oil groove comprises a shape of one of trapezoidal, rectangular and square.

3. The shell bearing as claimed in claim 1, wherein the oil groove is configured for a substrate of aluminum or bronze.

4. The shell bearing as claimed in claim 1, wherein the internal surface of the two segments comprises a coating.

5. The shell bearing as claimed in claim 1, wherein the oil groove comprises a width of between 1 mm and 7 mm.

6. The shell bearing as claimed in claim 1, wherein the oil groove comprises a depth of between 0.1 mm and 2 mm.

7. The shell bearing as claimed in claim 1, wherein the oil groove comprises a constant width of between 1 mm and 7 mm and a constant depth of between 0.1 mm and 2 mm.

8. The shell bearing as claimed in claim 1, wherein the oil groove extends entirely over a total extent of the at least one segment.

9. The shell bearing as claimed in claim 1, further comprising at least one oil hole disposed in the oil groove that penetrates through the at least one segment.

10. The shell bearing as claimed in claim 1, wherein the at least one segment comprises an aluminum substrate and the internal surface of the at least one segment is provided with a coating.

11. The shell bearing as claimed in claim 1, wherein the at least one segment comprises a bronze substrate and the internal surface of the at least one segment is provided with a coating.

12. An internal combustion engine, comprising:
a shell bearing including two semicircular segments defining a profile of the shell bearing;
the shell bearing including a constant oil groove extending longitudinal and in a centralized manner along an internal surface of at least one of the two segments;
wherein the oil groove comprises a volume in a proportion of up to 10% of a volume of the shell bearing.

13. The internal combustion engine as claimed in claim 12, wherein the oil groove has a shape of one of trapezoidal, rectangular, and square.

14. The internal combustion engine as claimed in claim 12, wherein the at least one segment comprises an aluminum substrate or a bronze substrate.

15. The internal combustion engine as claimed in claim 12, wherein the internal surface of the at least one segment comprises a coating.

16. The internal combustion engine as claimed in claim 12, wherein the oil groove has a constant width of between 1 mm and 7 mm.

17. The internal combustion engine as claimed in claim 12, wherein the oil groove has a constant depth of between 0.1 mm and 2 mm.

18. The internal combustion engine as claimed in claim 12, wherein the oil groove has a width of between 1 mm and 7 mm, and a depth of between 0.1 mm and 2 mm.

19. The internal combustion engine as claimed in claim 12, wherein the oil groove extends entirely over a total extent of the at least one segment.

20. The internal combustion engine as claimed in claim 12, wherein the shell bearing further comprises at least one oil hole disposed in the oil groove that penetrates through the at least one segment.
